(19) United States
(12) Patent Application Publication
(10) Pub. No.: US 2026/0206682 A1
(43) Pub. Date: Jul. 23, 2026

(54) Dual-Height Mowing System and Method of Use

(71) Applicant: Cole Gaines, Lebanon, MO (US)

(72) Inventor: Cole Gaines, Lebanon, MO (US)

(21) Appl. No.: 19/285,459

(22) Filed: Jul. 30, 2025

Related U.S. Application Data
(60) Provisional application No. 63/747,941, filed on Jan. 22, 2025.

(51) Int. Cl. A01D 34/66; A01D 34/74

(52) U.S. Cl. CPC A01D 34/664; A01D 34/74

(57) ABSTRACT

A dual-height disc cutting apparatus for mowing forage crops at multiple selectable lengths or heights in a single pass is disclosed. The apparatus comprises a mower frame configured to mount to or integrate with an agricultural vehicle, a top cutter bar assembly, and a bottom cutter bar assembly. Each cutter bar includes multiple rotatable disc units with high-speed rotating blades to sever forage at distinct heights above the ground. An adjustable mounting system enables independent vertical positioning of each cutter bar using hydraulic actuators, telescopic linkages, or mechanical height brackets. The top cutter bar can be laterally offset from the bottom cutter bar, enabling staged cutting of the forage crop. A user interface provides manual or electronic control of cutter bar height and lateral extension, enabling for optimized cutting based on terrain or forage type.

### CROSS REFERENCE TO RELATED APPLICATION

The present application claims priority to, and the benefit of, U.S. Provisional Application No. 63/747,941 which was filed on January 22, 2025 and is incorporated herein by reference in its entirety.

### FIELD OF THE INVENTION

The present invention generally relates to agricultural machinery and forage harvesting systems. More specifically, the present invention relates to a dual-height disc cutting apparatus configured to mow hay and forage crops at multiple predetermined lengths in a single pass. The invention comprises a modular mower frame and includes two vertically spaced cutter bar assemblies: a top cutter bar assembly and a bottom cutter bar assembly. Each cutter bar is equipped with a series of rotatable disc units featuring high-speed rotating blades designed to sever forage at distinct cutting heights. The apparatus further includes an adjustable mounting system that enables independent vertical adjustment of both cutter bars, enabling height control across varying terrain. The top cutter bar is laterally offset to engage crop material before the bottom bar, enabling staged cutting for improved feed processing. Accordingly, the present disclosure makes specific reference thereto. Nonetheless, it is to be appreciated that aspects of the present invention are also equally applicable to other like applications, devices, and methods of manufacture.

### BACKGROUND

By way of background, processing hay and forage for animal feed is a labor-intensive and time-consuming task. One of the important factors in producing high-quality feed is cutting forage at optimal lengths. Irregular lengths of forage are difficult to grind during feed processing. This, in turn, reduces the digestibility and palatability of the feed for livestock, often leading to waste and diminished nutritional intake.

Conventional hay mowers are typically designed to cut all plant material at a uniform height. However, agricultural fields often present uneven terrain and varying plant maturity, making it difficult to achieve consistent cutting results. Furthermore, trying to cut hay to multiple specific lengths using a standard mower is impractical and inefficient. Farmers and ranchers are often required to perform multiple passes or use additional tools, increasing fuel consumption, equipment wear, and overall operational time. Accordingly, individuals desire an improved mowing apparatus that enables simultaneous cutting of forage at multiple preset lengths in a single pass.

Therefore, there exists a long-felt need in the art for a forage harvesting device that enables cutting at multiple preset heights in a single operational pass. There is a long-felt need for a disc mower that can accommodate variations in terrain and crop maturity. Furthermore, there is a need for an agricultural mower system that can optimize forage for livestock consumption by improving palatability and ease of processing. Additionally, there is a long-felt need in the art for a dual-cutting system that reduces the time, equipment wear, and labor required to produce high-quality hay. Finally, there exists a need for a mower that offers a way for farmers and ranchers to cut hay at specific lengths without additional tools, power, and time.

The subject matter disclosed and claimed herein, in one embodiment, comprises a dual-height disc cutting apparatus designed for hay and forage harvesting. The apparatus includes a modular mower frame configured to be integrated with or mounted onto a variety of agricultural vehicles. A top cutter bar assembly is mounted to the frame and includes a plurality of rotatable disc units spaced along a first longitudinal axis, each disc featuring high-speed rotating blades configured to cut forage at a first, higher elevation. A bottom cutter bar assembly is mounted below and offset from the top cutter bar, comprising corresponding rotatable disc units arranged along a second longitudinal axis and configured to cut forage at a second, lower elevation. The assemblies are independently adjustable and are designed to follow ground contours during operation.

In one embodiment, the dual cutter bar assemblies are mounted to the mower frame via an adjustable mounting system. The system includes a pivoted bracket for the top cutter bar and a telescopic linkage arm for the bottom cutter bar, enabling independent vertical adjustment. The cutting heights for each bar assembly can be controlled manually, hydraulically, or electronically via an integrated or remote user interface.

In this manner, the dual-height disc cutting apparatus of the present invention addresses longstanding inefficiencies associated with traditional forage mowers. The apparatus provides a dual level cutting mechanism that enables staged cutting of plant material in a single pass, producing forage of varying lengths without requiring multiple machines or repeated field operations. The invention improves harvest quality, reduces processing burden for feed preparation, and enhances livestock digestion outcomes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual-height disc cutting apparatus for mowing forage crops at multiple preset lengths. The apparatus comprises a mower frame configured to be coupled to or integrated with an agricultural vehicle, a top cutter bar assembly mounted to the mower frame, the top cutter bar assembly comprises a plurality of rotatable disc units arranged along a first longitudinal axis, each rotatable disc unit comprises at least one high-speed rotating blade configured to sever forage at a first selectable height above ground level. A bottom cutter bar assembly operably is mounted below and in offset alignment with the top cutter bar assembly, the bottom cutter bar assembly comprises a second plurality of rotatable disc units arranged along a second longitudinal axis, each rotatable disc unit comprises at least one high-speed rotating blade configured to sever forage at a second selectable height lower than the first selectable height. An adjustable mounting system is configured to independently vary the vertical positions or heights of the top cutter bar assembly and the bottom cutter bar assembly relative to the ground.

In another embodiment, the top cutter bar assembly is positioned such that the rotatable disc units of the top cutter bar extend laterally beyond the rotatable disc units of the bottom cutter bar assembly to enable staged cutting of forage material at two different heights in a single mowing pass.

In one embodiment, a method for mowing forage material at multiple preset heights using a dual-height disc cutting apparatus is disclosed. The method comprises the steps of providing a mower frame with a top cutter bar assembly and a bottom cutter bar assembly mounted thereto, the top cutter bar assembly comprises a plurality of first rotatable disc units with blades adapted to sever forage at a first selectable height, and the bottom cutter bar assembly comprises a plurality of second rotatable disc units with blades adapted to sever forage at a second, lower height. The method further includes configuring an adjustable mounting mechanism to set a first vertical position for the top cutter bar assembly and a second, independent vertical position for the bottom cutter bar assembly, laterally extending the top cutter bar assembly beyond the bottom cutter bar assembly to create an offset cutting path, and actuating the disc units such that the top cutter bar severs a first portion of the forage crop at the first selectable height, and the bottom cutter bar severs a second portion at the second selectable height during a single pass over a crop field.

In still another embodiment, a user interface is configured to receive input commands for adjusting the cutting height of the top cutter bar assembly, the cutting height of the bottom cutter bar assembly, and the lateral extension of the top cutter bar assembly, wherein the system performs simultaneous staged cutting of forage at two separate heights in a single pass using the coordinated operation of the cutter bars and mounting system.

In yet another embodiment, the adjustable mounting system is operably connected to the top cutter bar assembly and the bottom cutter bar assembly. The adjustable mounting system comprises a pivoted bracket for the top cutter bar assembly and a telescopic linkage for the bottom cutter bar assembly, the system enables independent vertical and angular displacement of each cutter bar assembly.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of dual-height disc cutting apparatus of the present invention in accordance with the disclosed structure;

FIG. 2 illustrates an enlarged view of a rotatable disc unit used in the dual-height disc cutting apparatus of the present invention in accordance with the disclosed structure;

FIG. 3 illustrates a perspective view of the adjustable mounting system for the dual-height cutter bar assemblies in accordance with the disclosed structure; and

FIG. 4 illustrates a user interface for controlling operations of the dual-height disc cutting apparatus of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a forage harvesting device that enables cutting at multiple preset heights in a single operational pass. There is a long-felt need for a disc mower that can accommodate variations in terrain and crop maturity. Furthermore, there is a need for an agricultural mower system that can optimize forage for livestock consumption by improving palatability and ease of processing. Additionally, there is a long-felt need in the art for a dual-cutting system that reduces the time, equipment wear, and labor required to produce high-quality hay. Finally, there exists a need for a mower that offers a way for farmers and ranchers to cut hay at specific lengths without additional tools, power, and time.

The present invention, in one exemplary embodiment, is a method for mowing forage material at multiple preset heights using a dual-height disc cutting apparatus. The method comprises the steps of providing a mower frame with a top cutter bar assembly and a bottom cutter bar assembly mounted thereto, the top cutter bar assembly comprises a plurality of first rotatable disc units with blades adapted to sever forage at a first selectable height, and the bottom cutter bar assembly comprises a plurality of second rotatable disc units with blades adapted to sever forage at a second, lower height. The method further includes configuring an adjustable mounting mechanism to set a first vertical position for the top cutter bar assembly and a second, independent vertical position for the bottom cutter bar assembly, laterally extending the top cutter bar assembly beyond the bottom cutter bar assembly to create an offset cutting path, and actuating the disc units such that the top cutter bar severs a first portion of the forage crop at the first selectable height, and the bottom cutter bar severs a second portion at the second selectable height during a single pass over a crop field.

Reference will now be made in detail to the present preferred embodiments of the invention, examples of which are illustrated in the accompanying drawings. Wherever possible, the same reference numerals are used in the drawings and the description to refer to the same or like parts.

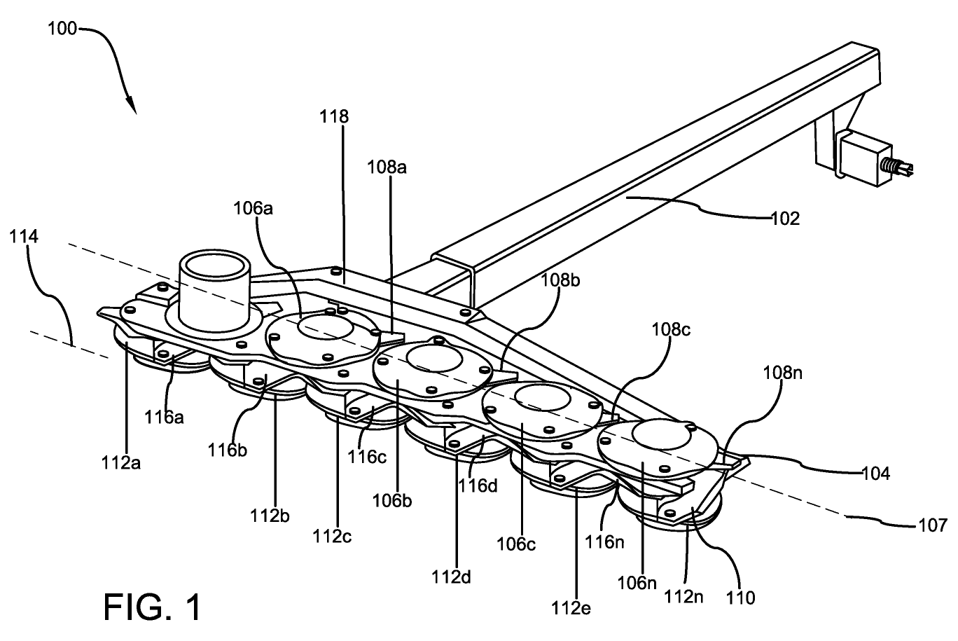

Referring initially to the drawings, FIG. 1 illustrates a perspective view of dual-height disc cutting apparatus of the present invention in accordance with the disclosed structure. The dual-height disc cutting apparatus 100 of the present invention is designed as an improved hay and forage mowing device that includes a dual-height cutting mechanism for more precise and flexible harvesting. The double disc cutter device 100 is designed primarily for agricultural use, particularly in hay and forage production, and enables users to mow plant material at multiple preset lengths using a two-cutter-bar system integrated into a disc mower.

As illustrated, the dual-height disc cutting apparatus 100 includes a mower frame 102. The mower frame 102 can be designed as a standalone mower frame or can also be integrated with an agricultural vehicle. The mower frame 102 can be modular and can also be removably coupled to the agricultural vehicle.

A top cutter bar assembly 104 is included in the dual-height disc cutting apparatus 100 and includes a plurality of rotatable disc units 106a-n spaced uniformly along a longitudinal axis 107 of the top cutter bar assembly 104. Each rotatable disc unit is a circular cutting disc and comprises a plurality of rotating blades 108a-n. In the preferred embodiment, the top cutter bar assembly 104 is rotatable to follow the contour of the terrain. The rotating blades are adapted for high-speed rotation to sever forage material at a first selectable height (equal to the height of the rotating disc units) above ground level.

A bottom cutter bar assembly 110 is operably mounted below and in offset alignment relative to the top cutter bar assembly 104. The bottom cutter bar assembly 110 includes a plurality of corresponding rotatable disc units 112a-n arranged along a longitudinal axis 114 of the bottom cutter bar assembly 110. Each rotatable disc unit of the corresponding rotatable disc units 112a-n is a circular cutting disc and comprises a plurality of rotating blades 116a-n. The rotating blades 116a-n are adapted to sever forage at a second selectable height lower than the first selectable height.

The apparatus 100 includes an adjustable mounting module 118 configured to independently vary the vertical positions or heights of the top cutter bar assembly 104 and the bottom cutter bar assembly 110 relative to the ground surface. The adjustable mounting system 118 can include one or more mounts selected from the group consisting of hydraulic actuators, telescopic linkages, and mechanical height-adjustment brackets.

It should be noted that the top cutter bar assembly 104 is positioned such that the corresponding disc units 106a-n extend laterally beyond the disc units 112a-n of the bottom cutter bar assembly 110, thereby enabling the top cutter bar assembly 104 to engage and cut a portion of the forage material prior to the bottom cutter bar assembly 110 engaging the remaining portion of the forage material. In another embodiment, the apparatus 100 using the dual cutter bar assemblies 104, 110 in alignment, enables for simultaneous cutting of the same forage crop at two different vertical heights in a single mowing pass, thereby producing forage of multiple lengths without requiring additional mower equipment, horsepower, or operational time.

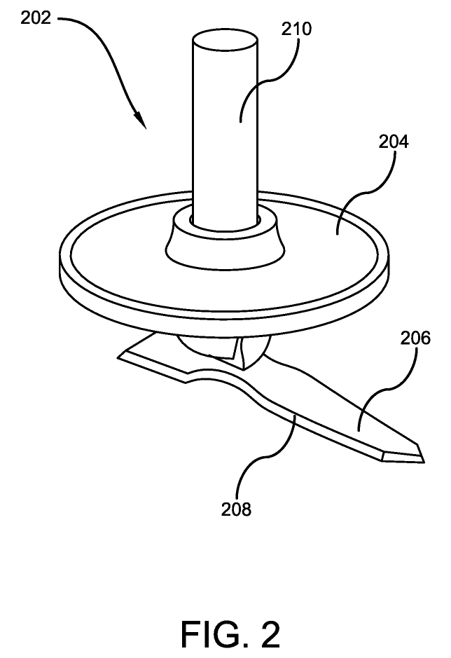

FIG. 2 illustrates an enlarged view of a rotatable disc unit used in the dual-height disc cutting apparatus of the present invention in accordance with the disclosed structure. As illustrated, the rotatable disc unit 202 (similar to the disc units 106a-n, 112a-n) includes a drive shaft 204 for rotating the at least one blade 206. The rotating blade 206 can be made from high-carbon steel or boron steel and can have a length from about 4 inches to about 8 inches. The blade 206 preferably has a beveled edge 208 for efficient cutting and can be configured to rotate clockwise or counterclockwise. The rotatable disc unit 202 is rotatably and removably coupled to the corresponding cutter bar assembly using the connecting bar 210 for a secure and efficient harvesting operation.

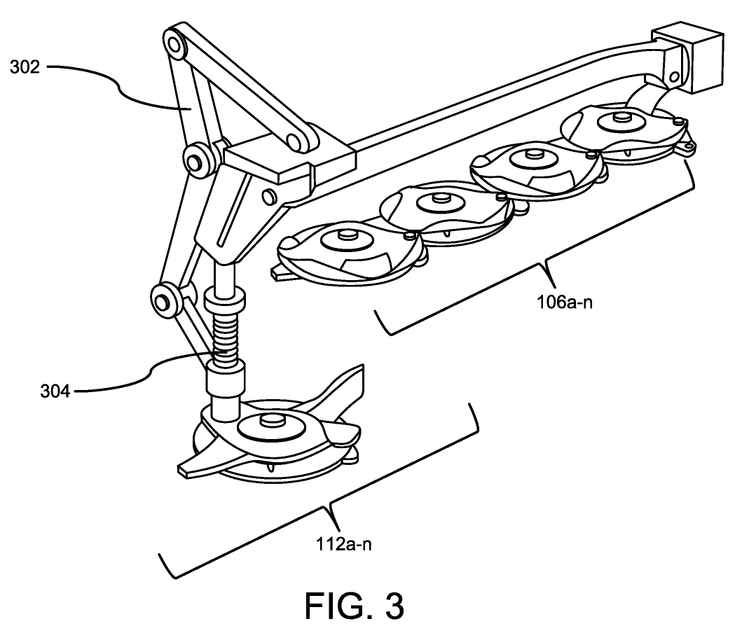

FIG. 3 illustrates a perspective view of the adjustable mounting system for the dual-height cutter bar assemblies in accordance with the disclosed structure. The adjustable mounting system 118 includes a pivoted bracket system 302 connected to the mower frame which enables vertical translation and angular adjustment of the top cutter bar assembly 104. The pivoted bracket system 302 enables independent adjustment of the top cutter bar assembly 104 and can be in the form of locking pins or hydraulic control for setting height.

The bottom cutter bar assembly 110 is connected to a separate and independent linkage arm 304 beneath the top cutter bar assembly 104. The linkage arm 304 is in the form of a telescopic rod and enables vertical displacement and fine height control independent of the top cutter bar assembly 104. The adjustable mounting mechanism 118 enables independent and precise control of the vertical positions or heights of both the top and bottom cutter bar assemblies independently and separately.

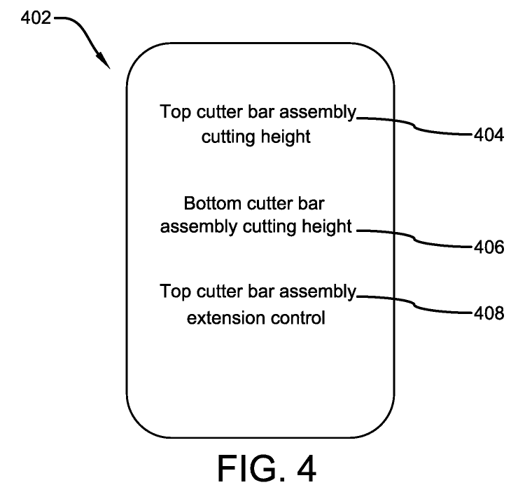

FIG. 4 illustrates a user interface for controlling operations of the dual-height disc cutting apparatus of the present invention in accordance with the disclosed structure. The apparatus 100 can be manually configured and operated using a user interface 402 which can be positioned on the apparatus 100 or can also be displayed by a software application on a remote device such as a smartphone, smartwatch or any electronic computing device. The user interface 402 displays a top cutter bar assembly cutting height 404 and a bottom cutter bar assembly cutting height 406. The top cutter bar assembly can be selectively and independently engaged (i.e., operated solely), and the cutting height 404 can be adjusted to automatically configure height of the top cutter bar assembly 104 for harvesting. Similarly, the bottom cutter bar assembly can be selectively and independently engaged (i.e., operated solely), and the cutting height 406 can be adjusted to automatically configure height of the bottom cutter bar assembly 110. A top cutter bar assembly extension control 408 enables a user to input information to extend the top cutter bar assembly 104 laterally beyond the disc units of the bottom cutter bar 110. It should be noted that in some embodiments, the user interface may not be electronic and the assemblies are controlled manually using manual or hydraulic means as described earlier in the disclosure.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual-height mowing system”, “dual-height disc cutting apparatus”, “adjustable mowing system”, and “system” are interchangeable and refer to the dual-height mowing system 100 of the present invention.

Notwithstanding the foregoing, the dual height mowing system 100 of the present invention can be of any suitable configuration as is known in the art without affecting the overall concept of the invention, provided that it accomplishes the above stated objectives. One of ordinary skill in the art will appreciate that the dual-height mowing system 100 as shown in the FIG. . are for illustrative purposes only, and that many other configurations of the dual-height mowing system 100 are well within the scope of the present disclosure. Although the dimensions of the dual-height mowing system 100 are important design parameters for user convenience, the dual-height mowing system 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual-height disc cutting apparatus comprising:
a dual-height cutting mechanism having a mower frame and a double disc cutter device;
wherein said double disc cutter device having a top cutter bar assembly and a bottom cutter bar assembly;
wherein said top cutter bar assembly having a first plurality of rotatable disc units spaced uniformly along a first longitudinal axis of said top cutter bar assembly;
wherein each of said first plurality of rotatable disc units is a circular cutting disc including a plurality of rotating blades;
wherein said first plurality of rotatable disc units having a first selectable height to sever forage material at a first selectable height;
wherein said bottom cutter bar assembly having a second plurality of rotatable disc units arranged along a second longitudinal axis of said bottom cutter bar assembly;
wherein each of said second plurality of rotatable disc units is a circular cutting disc including a plurality of rotating blades;
wherein said second plurality of rotatable disc units having a second selectable height to sever the forage material at a second selectable height; and
further wherein said second selectable height is lower than said first selectable height.

2. The dual-height disc cutting apparatus of claim 1 further comprising an adjustable mounting bracket to independently vary said first selectable height of said first plurality of rotatable disc units and said second selectable height of said second plurality of rotatable disc units relative to the ground surface.

3. The dual-height disc cutting apparatus of claim 2, wherein said adjustable mounting bracket selected from the group consisting of hydraulic actuators, telescopic linkages, and mechanical height-adjustment brackets.

4. The dual-height disc cutting apparatus of claim 3, wherein said top cutter bar assembly is rotatable with said adjustable mounting bracket to follow the contour of the terrain.

5. The dual-height disc cutting apparatus of claim 4, wherein said top cutter bar assembly in offset alignment relative to said bottom cutter bar assembly and extends laterally beyond said bottom cutter bar assembly, and further wherein said first plurality of rotatable disc units engage and cut a first portion of the forage prior to said second plurality of rotatable disc units engaging and cutting a second portion of the forage.

6. The dual-height disc cutting apparatus of claim 5, wherein said adjustable mounting bracket having a pivotable bracket connected to said mower frame for independent vertical translation and angular adjustment of said top cutter bar assembly.

7. The dual-height disc cutting apparatus of claim 6, wherein said adjustable mounting bracket having a linkage arm connected to said bottom cutter bar assembly, and further wherein said linkage arm is a telescopic rod for independent vertical displacement and height control of said bottom cutter bar assembly.

8. The dual-height disc cutting apparatus of claim 4, wherein said top cutter bar assembly is aligned with said bottom cutter bar assembly, and further wherein said first plurality of rotatable disc units engage and cut a first portion of the forage simultaneously with said second plurality of rotatable disc units engaging and cutting a second portion of the forage.

9. The dual-height disc cutting apparatus of claim 8, wherein said adjustable mounting bracket having a pivotable bracket connected to said mower frame for independent vertical translation and angular adjustment of said top cutter bar assembly.

10. The dual-height disc cutting apparatus of claim 9, wherein said adjustable mounting bracket having a linkage arm connected to said bottom cutter bar assembly, and further wherein said linkage arm is a telescopic rod for independent vertical displacement and height control of said bottom cutter bar assembly.

11. The dual-height disc cutting apparatus of claim 10, wherein said mower frame is a standalone mower frame.

12. The dual-height disc cutting apparatus of claim 10, wherein said mower frame is a modular frame that is selectively coupled to an agricultural vehicle.

13. A dual-height disc cutting apparatus comprising:
a dual-height cutting mechanism having a mower frame, a double disc cutter device, and an adjustable mounting bracket;
wherein said double disc cutter device having a top cutter bar assembly and a bottom cutter bar assembly;
wherein said top cutter bar assembly having a first plurality of rotatable disc units spaced uniformly along a first longitudinal axis of said top cutter bar assembly;
wherein each of said first plurality of rotatable disc units is a circular cutting disc including a plurality of rotating blades;
wherein said first plurality of rotatable disc units having a first selectable height to sever forage material at a first selectable height;
wherein said bottom cutter bar assembly having a second plurality of rotatable disc units arranged along a second longitudinal axis of said bottom cutter bar assembly;
wherein each of said second plurality of rotatable disc units is a circular cutting disc including a plurality of rotating blades;
wherein said second plurality of rotatable disc units having a second selectable height to sever the forage material at a second selectable height;
wherein said second selectable height is lower than said first selectable height;
wherein said top cutter bar assembly in offset alignment relative to said bottom cutter bar assembly and extends laterally beyond said bottom cutter bar assembly;
wherein said first plurality of rotatable disc units engage and cut a first portion of the forage prior to said second plurality of rotatable disc units engaging and cutting a second portion of the forage;
wherein said adjustable mounting bracket independently varies said first selectable height of said first plurality of rotatable disc units and said second selectable height of said second plurality of rotatable disc units relative to the ground surface;
wherein said adjustable mounting bracket having a pivotable bracket connected to said mower frame for independent vertical translation and angular adjustment of said top cutter bar assembly;
wherein said adjustable mounting bracket having a linkage arm connected to said bottom cutter bar assembly; and
further wherein said linkage arm is a telescopic rod for independent vertical displacement and height control of said bottom cutter bar assembly.

14. The dual-height disc cutting apparatus of claim 13, wherein said adjustable mounting bracket selected from the group consisting of hydraulic actuators, telescopic linkages, and mechanical height-adjustment brackets.

15. The dual-height disc cutting apparatus of claim 13, wherein said top cutter bar assembly is rotatable with said adjustable mounting bracket to follow the contour of the terrain.

16. The dual-height disc cutting apparatus of claim 13, wherein said mower frame is a standalone mower frame.

17. The dual-height disc cutting apparatus of claim 13, wherein said mower frame is a modular frame that is selectively coupled to an agricultural vehicle.

18. A dual-height disc cutting apparatus comprising:
a dual-height cutting mechanism having a mower frame, a double disc cutter device, and an adjustable mounting bracket;
wherein said double disc cutter device having a top cutter bar assembly and a bottom cutter bar assembly;
wherein said top cutter bar assembly having a first plurality of rotatable disc units spaced uniformly along a first longitudinal axis of said top cutter bar assembly;
wherein each of said first plurality of rotatable disc units is a circular cutting disc including a plurality of rotating blades;
wherein said first plurality of rotatable disc units having a first selectable height to sever forage material at a first selectable height;
wherein said bottom cutter bar assembly having a second plurality of rotatable disc units arranged along a second longitudinal axis of said bottom cutter bar assembly;
wherein each of said second plurality of rotatable disc units is a circular cutting disc including a plurality of rotating blades;
wherein said second plurality of rotatable disc units having a second selectable height to sever the forage material at a second selectable height;
wherein said second selectable height is lower than said first selectable height;
wherein said top cutter bar assembly in offset alignment relative to said bottom cutter bar assembly and extends laterally beyond said bottom cutter bar assembly;
wherein said first plurality of rotatable disc units engage and cut a first portion of the forage prior to said second plurality of rotatable disc units engaging and cutting a second portion of the forage;
wherein said adjustable mounting bracket independently varies said first selectable height of said first plurality of rotatable disc units and said second selectable height of said second plurality of rotatable disc units relative to the ground surface;
wherein said top cutter bar assembly is rotatable with said adjustable mounting bracket to follow the contour of the terrain; and
further wherein said adjustable mounting bracket selected from the group consisting of hydraulic actuators, telescopic linkages, and mechanical height-adjustment brackets.

19. The dual-height disc cutting apparatus of claim 18, wherein said adjustable mounting bracket having a pivotable bracket connected to said mower frame for independent vertical translation and angular adjustment of said top cutter bar assembly, wherein said adjustable mounting bracket having a linkage arm connected to said bottom cutter bar assembly, and further wherein said linkage arm is a telescopic rod for independent vertical displacement and height control of said bottom cutter bar assembly.

20. The dual-height disc cutting apparatus of claim 19, wherein one of said first plurality of rotatable disc units and said second plurality of rotatable disc units selectively and independently operable.
